(19) United States
(12) Patent Application Publication
(10) Pub. No.: US 2022/0003657 A1
(43) Pub. Date: Jan. 6, 2022

(54) METHOD FOR OPERATING A PARTICLE SENSOR

(71) Applicant: Robert Bosch GmbH, Stuttgart (DE)

(72) Inventors: Matthias Wichmann, Gaertringen (DE); Radoslav Rusanov, Stuttgart (DE)

(73) Assignee: Robert Bosch GmbH, Stuttgart (DE)

(21) Appl. No.: 17/294,235

(22) PCT Filed: Oct. 14, 2019
(86) PCT No.: PCT/EP2019/077705

§ 371 Date: May 14, 2021

(30) Foreign Application Priority Data
Nov. 20, 2018 (DE) 10 2018 219 891.8

(51) Int. Cl. G01N 15/14

(52) U.S. Cl. CPC G01N 15/1434; G01N 2015/0046; G01N 2015/1486; G01N 2015/1493

(57) ABSTRACT

A method for operating a particle sensor. The particle sensor includes a laser module having a laser, and a detector configured to detect thermal radiation, an optical element positioned in the optical path of the laser of the laser module. The optical element is configured to focus laser light emanating from the laser module onto a spot, and the detector is positioned in the particle sensor in such a manner that it detects radiation emanating from the spot. The method includes subjecting the output signals of the detector to filtering, by which output signals generated by particles not sufficiently heated are excluded from further evaluation. A control unit configured to operate the particle sensor is also described.

### FIELD

The present invention relates to a method for operating a particle sensor, and to a control unit.

The particle sensor used in the method includes a laser module having a laser, and a detector configured to detect thermal radiation, an optical element positioned in the optical path of the laser of the laser module, and a detector. The optical element is configured to focus the laser light emanating from the laser module onto a spot. The detector of the particle sensor is positioned in such a manner, that it detects radiation emanating from the spot.

### BACKGROUND INFORMATION

Motor vehicles powered by modern diesel engines are equipped with particle filters. According to legal regulations, the operability of these particle filters must be monitored by onboard diagnostic devices. In this context, for example, sensors, which include an electrical resistor and are manufactured and marketed by the applicant, are used for motor vehicles. The method of functioning of these conventional sensors is based on the formation of conductive soot paths between two interdigital electrodes. In these sensors, the rise time of the current after application of a voltage is a measure of the soot concentration. In this context, the mass concentration (mg/m³ of exhaust gas and/or mg/km of distance traveled) is measured. In this sensor design, for various reasons, it is very difficult or even impossible to calculate the numerical concentration (number of particles per m³ of exhaust gas and/or per km of distance traveled). The conventional sensor is regenerated periodically by heating it to at least 700° C., using an integrated heating element, through which the soot deposits burn off.

In the scientific community, which studies the health effects of the fine particles, there have long been discussions about which of the quantities, total mass of particulate (indicated in mg/m³ or in mg/km) or number n of particles (n/m³ or n/km), is the more critical quantity with regard to health effects. In this context, it must be taken into consideration that even the small soot particles, which make up only a small portion of the overall mass due to their very low mass (m˜r³), are particularly dangerous. This is due to their high level of “penetration” into the human body, which results from their small size. Therefore, it is foreseeable that the legislation, Onboard Diagnostic Devices for Technical Measurement, will also specify the particle number, as soon as appropriate solutions (acceptable with regard to performance and price) are available on the market.

The principle of laser-induced incandescence (LII) for detecting nanoparticles (in air) has been used already for a long time and is also used intensively for, e.g., characterizing the combustion process in “glass” engines in the laboratory, or for exhaust-gas characterization in laboratory environments. In this context, the soot particles are heated by a nanosecond pulse of a high-power laser to several thousand degrees Celsius, so that they emit a significant amount of thermal radiation. This thermally induced light emission of the soot particles is measured by a light sensor. The method allows the detection of very small soot particles having a diameter down to a magnitude of a few tens of nm.

In this context, pulsed lasers have been used for the simultaneous detection of a plurality of particles and CW (continuous wave) lasers have been used for the detection of individual particles. In this connection, U.S. Patent Application Publication No. US 2003/197863 A shows the use of the heating of an ensemble of particles by a high-power nanosecond laser, which attains a very high light intensity for a short time (ns). The operation takes place in the collimated (parallelly oriented) part of the beam having a cross section of several square centimeters or millimeters. Consequently, thousands of soot particles are simultaneously heated up by a single laser pulse, which does not allow a count of individual particles. In addition, a laser, which is cost-intensive and not capable of being miniaturized, is used here.

In U.S. Patent Application No. US 2001/0767104, the same method of functioning is used as in US 2003/197863 A, but with the difference that the latter document relates to a closed device, which has an inlet for the exhaust gas transporting the particles. The measurement of the particles takes place inside of the device.

### SUMMARY

The method of the present invention differs from this related art, for example, since the output signals of the detector are subjected to filtering, by which output signals generated by particles not sufficiently heated are excluded from further evaluation. The control unit of the present invention differs from this related art, for example, since it is configured to execute these method steps.

The particle sensor used in the method of an example embodiment of the present invention operates, using a focused laser beam having a very high intensity, in order to heat the soot particles flying through the laser spot to several thousand degrees. The thermally emitted light of the heated-up particles is used as a measuring signal. A continuously operating (CW) laser, whose beam is focused by suitable optical elements (e.g., lenses) onto a very small spot, is used in the present invention introduced here. Inexpensive semiconductor laser diodes may be used as a laser source, which reduces the cost of the particle sensor considerably. The LII light may be detected, e.g., with the aid of a sensitive photodiode or a multi-pixel photon counter (MPPC).

The method of an example embodiment of the present invention allows a measurement of both the numerical concentration and the mass concentration of particles in a fluid. The fluid may be a gas or a liquid. The particles are, for example, droplets of liquid in an aerosol or soot particles in the exhaust gas of diesel or gasoline vehicles. The method of the present invention enables detection of individual particles in a test volume, so that the particle size may also be determined from the measurement data.

An example embodiment of the present invention permits, in particular, an onboard diagnosis of the condition of particle filters in the exhaust system of internal combustion engines. To that end, the sensor is positioned in the exhaust-gas stream, downstream from the particle filter. The particle sensor operated, using the method of the present invention, has an advantageously short response time and is operational immediately after being activated, by switching on the laser. The ability to measure the number of particles that is possible in the method of the present invention, as well as the immediate readiness of the sensor for use directly after the vehicle is started, are very important in gasoline-powered vehicles, since in the case of gasoline engines, a majority of the typically highly fine particles (low mass, high number) are formed during cold-starting.

From the detected signal, the filtering of an example embodiment of the present invention allows particles, which have flown through the laser spot, to be distinguished from particles, which have flown past the laser spot at a comparatively short distance, and allows the particles last mentioned to be distinguished from particles, which have flown past the laser spot at a comparatively long distance. The particles mentioned last are not evaluated and are therefore filtered out.

Consequently, it is ensured that all of the evaluated particles have reached an approximately equal temperature (saturation temperature ˜3500 K). The signal intensity is only a direct function of the particle size in this case of approximately equal temperature. Conversely, this allows the particle size to be determined from the signal intensity.

In addition, such filtering provides for a clearly defined magnitude of the detection volume and/or cross section, through which an exact volumetric concentration of the particles is able to be extracted from the measured data. The high accuracy of the determination of the detection volume allows an exact determination of concentration (particles/m³ or particles/km). The high accuracy of the size determination allows an accurate determination of the particle mass (mg/m³ and/or mg/km).

The method of an example embodiment of the present invention may be used not only for determining particle masses and particle concentrations in the exhaust gas of internal combustion engines, but also for other scenarios and fields of application, such as for portable emissions monitoring systems, measurements of ambient air quality, and measurements of emissions of incinerators (private, industrial), this list not being complete.

One preferred refinement of the present invention includes that the filtering takes place in such a manner, that peaks, which have a characteristic double-peak structure, are excluded from further evaluation.

It is also preferable for the characteristic double-peak structure to be detected with the aid of a signal processing method.

It is further preferable for the signal processing method to be carried out using pattern recognition by artificial intelligence or the fitting of a curve of the double-peak structure to a sample curve shape, or by algorithms for finding high reference points of the double-peak structure and for evaluating an interval of the high reference points.

A further preferred refinement of the present invention includes that the filtering is based on an evaluation of the interval of peaks in the output signal of the detector.

It is also preferable for a first peak to be detected in the output signal of the detector, and for a decision as to whether the detected, first peak is counted as an event indicating a particle, to be a function of whether a further peak is detected in the output signal of the detector within a specified, first period of time t1, which begins with the detection of the first peak.

In addition, it is preferable for first period of time t1 to be specified as a function of a speed of the fluid, which transports the particles.

One further preferred refinement of the present invention includes that a time span, which has elapsed since the detection of the first peak, is measured, and that the first peak is counted as a particle, if no further peak is detected in the output signal of the detector within the specified, first period of time.

If a second peak is detected within first period of time t1, it is then also preferable for it to be checked whether the second peak has been detected within a period of time t2, which is shorter than first period of time t1; and if the second peak is detected within the second period of time, it is preferable for the first peak and the second peak of a double peak to be counted together as a particle.

In addition, it is preferable for the height of a peak to be evaluated as a measure of the size of the particle.

A further preferred refinement distinguishes itself in that a height of the first peak of the double peak is evaluated as a measure of the size.

It is also preferable for the radiation emanating from the spot to be subjected to wavelength filtering, in which wavelengths in the wavelength range of the laser beam are excluded.

In view of refinements of the control unit in accordance with the present invention, it is preferable for it to be configured, in particular, programmed, to execute a method according to one of the above-mentioned refinements of the method.

Further advantages are derived from the description herein and the figures.

It is understood that the features mentioned above and still to be explained below may be used not only in the respectively indicated combination, but also in other combinations, or by themselves, without departing from the scope of the present invention.

Exemplary embodiments of the present invention are depicted in the figures and explained in greater detail in the following description. In this context, identical reference numerals in different figures each denote the same elements or elements comparable with regard to at least their function.

### BRIEF DESCRIPTION OF THE DRAWINGS

FIG. 1 shows a measuring principle, which is based on laser-induced incandescence and is used in an example embodiment of the present invention.

FIG. 2 shows a basic layout of a soot particle sensor according to an example embodiment of the present invention.

FIG. 3 shows an exemplary embodiment of a soot particle sensor according to an example embodiment of the present invention.

FIG. 4 shows a simulated, schematic intensity distribution about the laser spot, and the trajectory of a particle, which flies past the laser spot.

FIG. 5 shows an LII signal (intensity of the thermal radiation emanating from a particle) versus time, for a particle flying laterally past the center of the laser spot.

FIG. 6 shows a flow chart as an exemplary embodiment of a method according to the present invention.

FIG. 7 shows an LII signal versus time, for a particle flying through the center of the laser spot.

### DETAILED DESCRIPTION OF EXAMPLE EMBODIMENTS

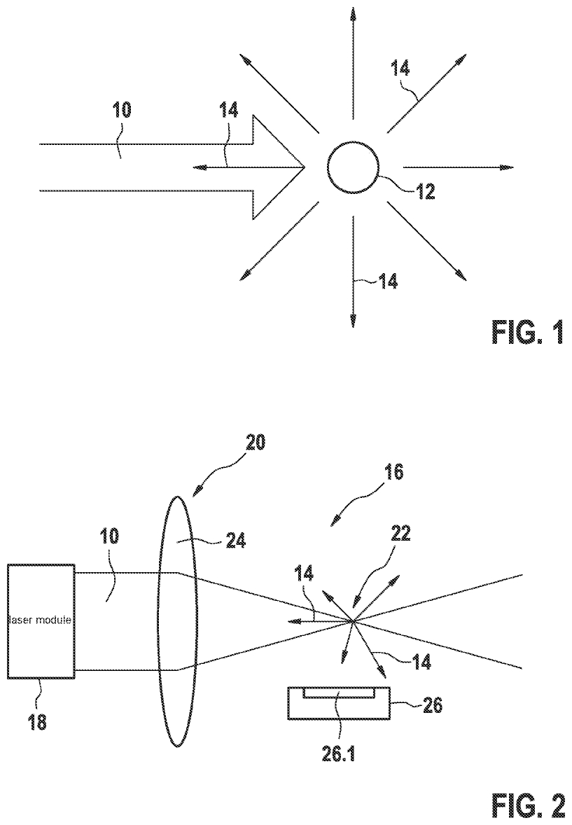

FIG. 1 illustrates the measuring principle based on laser-induced incandescence (LII). Laser light 10 of high intensity strikes a soot particle 12. The intensity of laser light 10 is so high, that the energy of laser light 10 absorbed by soot particle 12 heats soot particle 12 to several thousand degrees Celsius. As a result of the heating, soot particle 12 emits significant radiation 14 spontaneously and substantially without a preferential direction, in the form of thermal radiation also referred to below as LII light. Therefore, a part of the radiation 14 emitted in the form of thermal radiation is also emitted in a direction opposite to the direction of incident laser light 10.

FIG. 2 schematically shows a basic layout of an exemplary embodiment of a soot particle sensor 16 according to the present invention. Here, soot particle sensor 16 includes a CW (continuous wave) laser module 18, whose preferably parallel laser light 10 is focused onto a very small spot 22 by at least one optical element 20 positioned in the optical path of CW laser module 18. CW laser module 18 is preferably operated at lower power outputs, in particular, at power outputs between 50 mW and 500 mW, sometimes up to 5000 mW, as well. Optical element 20 is preferably a first lens 24. The intensity of laser light 10 only attains the high values necessary for LII in the volume of spot 22.

The dimensions of spot 22 are in the range of several micrometers, in particular, in the range of, for example, ten micrometers. In the case of an assumed particle concentration of 10¹³ per m³, then, at typical exhaust-gas speeds of internal combustion engines, it may be assumed that always, only one particle flies through spot 22 at a given time and is induced to emit evaluable radiant power, be it by laser-induced incandescence or by chemical reactions (in particular, oxidation). As a result, it may be assumed that, at most, one soot particle 12 is always located in spot 22, and that an instantaneous measuring signal of soot particle sensor 16 only comes from this, at the most, one soot particle 12. The measuring signal is generated by a detector 26, which is positioned in soot particle sensor 16 in such a manner, that it detects radiation 14, in particular, thermal radiation, emanating from soot particles 12 flying through spot 22. To that end, detector 26 preferably includes at least one photodiode 26.1. Consequently, a measurement of a single particle is possible, which enables information about soot particle 12, such as size and speed, to be extracted.

This allows the speed of the exhaust gas to be determined, and it becomes possible to calculate a particle-size spectrum. The first quantity is important for calculating the numerical concentration of soot particles 12. The mass concentration may also be calculated in combination with the second quantity. This constitutes a clear advantage over other measuring methods for measuring soot particles.

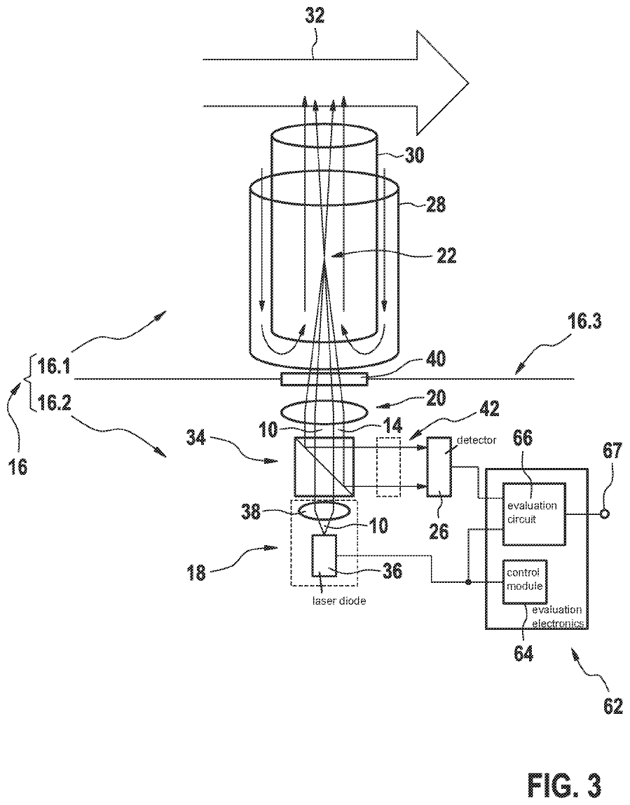

FIG. 3 shows an advantageous exemplary embodiment of a soot particle sensor 16 according to the present invention, which is suitable for use as a soot particle sensor in the exhaust gas of a combustion process.

Soot particle sensor 16 includes a set-up made up of an outer protective tube 28 and an inner protective tube 30. The two protective tubes 28, 30 preferably have a general cylindrical shape or prismatic shape. The bases of the cylindrical shapes are preferably circular, elliptical or polygonal. The cylinders are preferably positioned coaxially; the axes of the cylinders being oriented transversely to the flow of exhaust gas 32. In the direction of the axes, inner protective tube 30 extends out past outer protective tube 28 into the flowing exhaust gas 32. Outer protective tube 28 extends out past inner protective tube 30 at the end of the two protective tubes 28, 30 facing away from the flowing exhaust gas. The inner diameter of outer protective tube 28 is preferably so much greater than the outer diameter of inner protective tube 30, that a first flow cross-section forms between the two protective tubes 28, 30. The inner diameter of inner protective tube 30 forms a second flow cross-section.

The result of this geometry is that exhaust gas 32 enters the set-up of the two protective tubes 28, 30 through the first flow cross section, then changes its direction at the end of the protective tubes 28, 30 facing away from exhaust gas 32, enters into inner protective tube 30, and is sucked out of this by exhaust gas 32 flowing past. In this instance, laminar flow is produced in inner protective tube 30. This set-up of protective tubes 28, 30 is mounted, with soot particle sensor 16, to and/or in an exhaust pipe, transversely to the flow of exhaust gas.

In addition, soot particle sensor 16 includes laser module 18, which preferably generates parallel laser light 10. A beam splitter 34 is situated in the optical path of the preferably parallel laser light 10. A portion of the laser light 10 passing through beam splitter 34 without being deflected is focused by optical element 20 onto a very small spot 22 in the interior of inner protective tube 30. In this spot 22, the light intensity is high enough to heat soot particles 12 transported by exhaust gas 32 to several thousand degrees Celsius, so that heated soot particles 12 emit radiation 14 significantly in the form of thermal radiation. Radiation 14 is, for example, in the near infrared and visible spectral range, having a maximum in the red range (at app. 750 nm), without the present invention being limited to radiation from this spectral range. A portion of this radiation 14, that is, this LII light, emitted nondirectionally in the form of thermal radiation is acquired by optical element 20 and directed by beam splitter 34 onto detector 26. This design has the particularly important advantage that only one optical opening to exhaust gas 32 is needed, since the same optics, in particular, the same optical element 20, is used for producing spot 22 and for acquiring the radiation 14 emanating from soot particle 12. Exhaust gas 32 is, for example, a measuring gas. The measuring gas may also be a different gas or gas mixture, such as ambient air, or a liquid.

In the case of the subject matter of FIG. 3, laser module 18 includes a laser diode 36 and a second lens 38, which preferably orients the laser light 10 emanating from laser diode 36 parallelly. The use of laser diode 36 constitutes a particularly cost-effective and easily manipulable option for generating laser light 10. The preferably parallel laser light 10 is focused by optical element 20 towards spot 22.

Optical soot particle sensor 16 preferably includes a first part 16.1 exposed to the exhaust gas and a second part 16.2, which is not exposed to the exhaust gas and contains the optical components of soot particle sensor 16. The two parts are separated by a dividing wall 16.3, which runs between protective tubes 28, 30 and the optical elements of the soot particle sensor. Wall 16.3 is used for insulating the sensitive optical elements from the hot, chemically aggressive and “dirty” exhaust gas 32. A protective window 40, through which laser light 10 strikes exhaust gas 32, and via which radiation 14 emanating from spot 22 may fall upon optical element 20 and, from there, may strike detector via beam splitter 34, is mounted in dividing wall 32 in the optical path of laser light 10.

As an alternative to the exemplary embodiment represented here, the generation of spot 22 and the acquisition of radiation 14 emanating from soot particles in the spot may also take place via separate optical paths. In principle, it would be possible for the laser light to be guided from the light source to the focusing lens with the aid of an optical waveguide and appropriate coupling and decoupling optical elements. The same also applies to the LII light to be detected, which emanates from particles heated up in the spot. It is also not absolutely necessary for the laser light and the LII light to be correspondingly focused and collected by the same lens. In principle, the present invention may be applied to any LII sensor, as long as the particles are heated by a focused CW laser and the guidance of the exhaust gas stream and the laser beam run at least partially in parallel.

It is also possible to generate spot 22, using combinations of lenses different from the one specified here merely as an exemplary embodiment. In addition, soot particle sensor 16 may also be implemented, using sources of laser light different from the laser diodes 36 indicated here for exemplary embodiments.

FIG. 3 also shows an optional, additional filter 42, which is positioned in the optical path between beam splitter 34 and detector 26. Filter 42 distinguishes itself in that it is less transparent to laser light 10 than to radiation 14, which emanates from spot 22 when a soot particle 12 is located there.

This exemplary embodiment markedly improves the signal-to-noise ratio of the light striking detector 26, since it sharply reduces the amount of laser light 10, which would strike detector 26 due to laser light 10 being reflected back by the optical components of soot particle sensor 16. Such laser light would generate disruptive, additional shot noise, which would make detection of the radiation 14 in the form of thermal radiation emanating from soot particles in spot 22 more difficult. The interfering noise background for the pulses of radiation 14 emitted by soot particles 12, e.g., in the form of thermal radiation, is reduced by filter 42. The exemplary embodiment having filter 42 specifically takes advantage of the narrow bandwidth of laser sources (e.g., laser diodes), by filtering out precisely this narrow bandwidth in front of light detector 26. The use of a simple cut-off filter is also possible. This allows the signal-to-noise ratio to improve quite considerably.

In the case of installation of soot particle sensor 16 in an exhaust gas line of a combustion process, the filtering-out of the excitation light (laser light) accomplished by filter 42, in conjunction with the almost complete absence of outside/ambient light in the exhaust-gas line, allows the use of particularly sensitive detectors 26, such as inexpensive SiPM (silicon photomultipliers) or SPAD diodes (single-photon avalanche diode). As a result, a light signal, which is generated by a particularly small soot particle, is therefore extremely small, and is formed by, for example, a few tens of photons, may already be detected. This decreases the dimensions of soot particles, which are only just detectable, to a lower detection limit of 10 to 100 nm.

Control and evaluation electronics 62 may be a separate control unit, or they may be integrated in a control unit, which is used for controlling the combustion process. Control and evaluation electronics 62 include a control module 64, which controls the intensity of laser light 10 emanating from laser module 18. According to the present invention, that is, using the method of the present invention or one of its refinements, the signal of detector 26 is processed in the control unit by an evaluation circuit 66, which includes, for this, e.g., a microprocessor and a storage device, in which instructions for carrying out a method of the present invention are stored. Results of the processing are provided, for example, at an output 67 of evaluation circuit 66 or of control and evaluation electronics 62.

A general problem of such an LII-based particle sensor and of any other LII-based particle sensor is that a small particle in the center of the laser spot possibly generates the same signal as a larger particle at the edge of the spot. Consequently, it is no longer possible to determine the size of the particles from the measured signal amplitudes. The present invention provides a solution to this problem for an LII sensor having guidance of the exhaust-gas stream at least partially parallel to the laser beam.

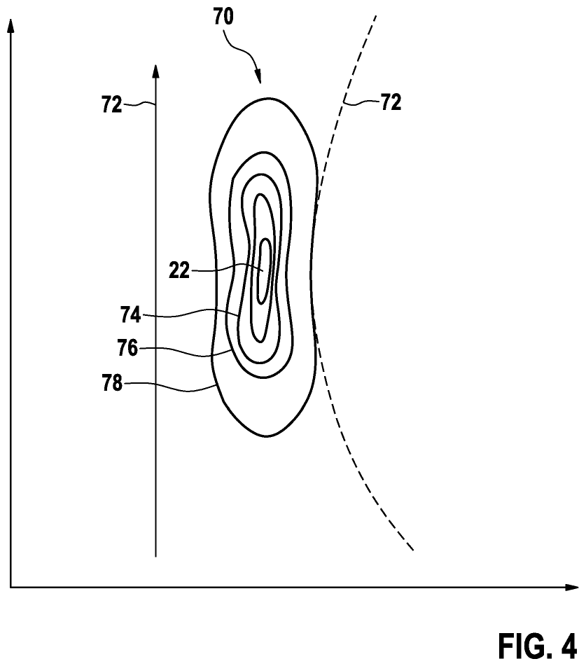

FIG. 4 shows a simulated, schematic intensity distribution 70 about the laser spot, along the direction of propagation of the beam, as well as the trajectory 72 of a particle, which flies past laser spot 22. Closed curves 74, 76, 78 are lines of constant radiation intensity. In each instance, the radiation intensity along a closed curve 74, 76, 78 is constant, and in the case of curves adjacent to each other, it decreases from the inside outwards. The direction of the laser beam is parallel to the direction of flow of the fluid transporting the particles, that is, parallel to the direction of trajectory 72. Spot 22 includes a necked-down portion. This means that each individual curve 74, 76, 78 of constant intensity has a throat. The concave necked-down portion is illustrated by dashed line 79. The physical units of the abscissa and the ordinate are each lengths. Spot 22 is at the narrowest position of the throat.

For a particle flying by laser spot 22, the throat shape has the effect that, while flying past laser spot 22, the distance of such a particle from, in each instance, the nearest point of such a closed curve 74, 76, 78 has a local maximum, which lies between two local minima. The radiation intensity of the laser spot is locally maximal at the local minima of the distance, and the radiation intensity of the laser spot is locally minimal at the local maxima of the distance.

Accordingly, the temperature of the particle heated up by the laser beam has a local temperature maximum at each local minimum of the distance, and a local temperature minimum at the local maximum of the distance. In accordance with the temperature of the particle, the thermal radiation emanating from the particle has a local thermal-radiation maximum at each local minimum of the distance, and a local thermal-radiation minimum at the local maximum of the distance. As a result, the thermal radiation of a particle flying past laser spot 22 at a lateral distance has a double peak.

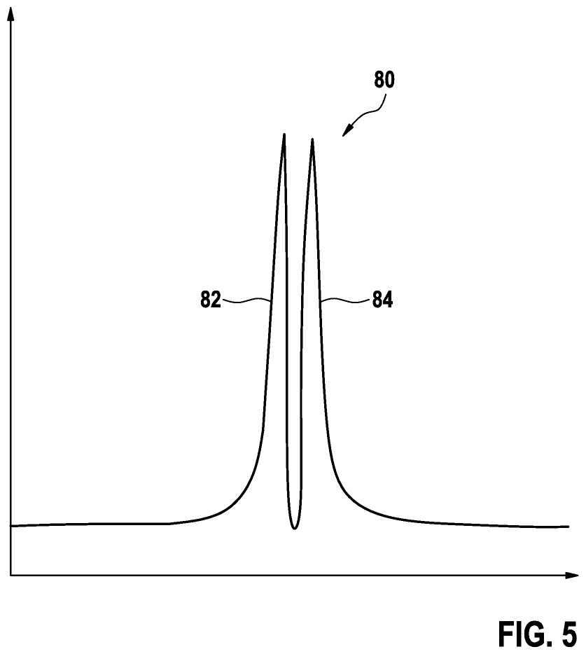

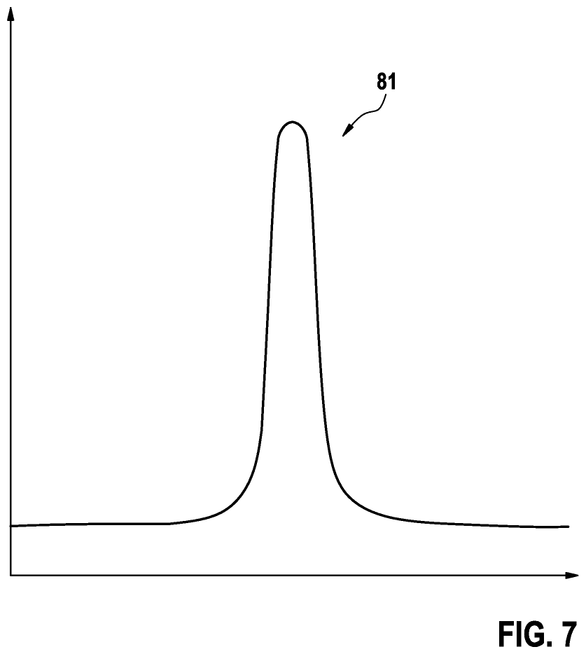

FIG. 5 shows such a double peak 80 of the thermal radiation versus time of a particle flying past laser spot 22 laterally. While a particle flying through the center of laser spot 22 generates only one intensity peak, the double peak structure apparent in FIG. 5 is characteristic of a particle flying past laser spot 22 laterally (trajectory 72). It has been shown that as the lateral distance from laser spot 22 of a particle flying past laser spot 22 becomes larger, the interval of peaks 82, 84 of the double peak becomes larger, as well. FIG. 7 shows the single peak of an LII signal versus time, for a particle flying through the center of the laser spot.

The double-peak structure characteristic of the lateral fly-by may be detected with the aid of different signal-processing methods, e.g., pattern recognition with the aid of artificial intelligence, fitting of the curve to a known curve shape, or by simple algorithms for finding high reference points and comparing their temporal positions.

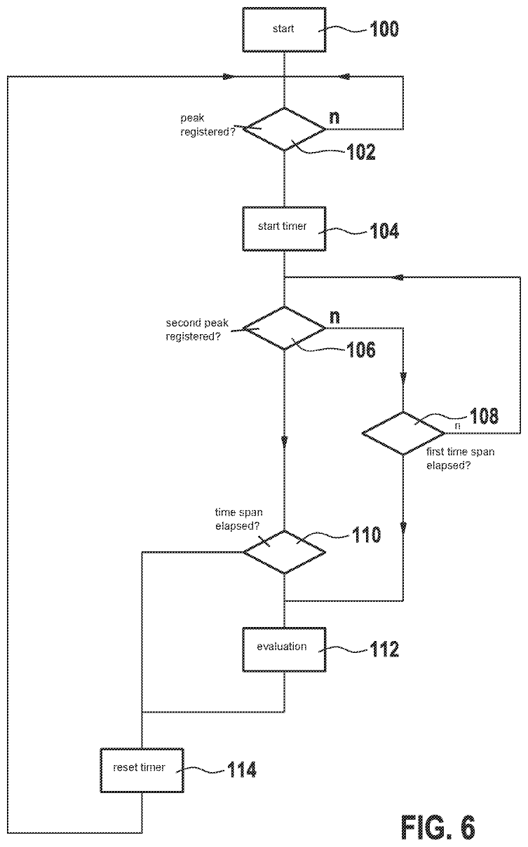

FIG. 6 shows a flow chart as an exemplary embodiment of a method of the present invention for distinguishing signals, which are generated by a particle flying through laser spot 22 close to the center, from signals, which are generated by particles flying past laser spot 22 laterally less closely to the center. The flow chart represented in FIG. 6 is also an exemplary embodiment of a refinement of the method according to the present invention, by which signals of particles, whose lateral distance from the center of laser spot 22 is comparatively short, may be distinguished from signals of particles, whose lateral distance from the center of laser spot 22 is comparatively long. This distinction may be used for filtering out the particles flying past at a relatively long distance. Therefore, measuring errors, which could be caused by comparatively overly weak heating of the particles mentioned above, may be prevented. Due to their lower thermal radiation in comparison with hotter particles, such particles would be rated erroneously as particles having a lower mass, which would invalidate a determination of the particle mass. The method is carried out, for example, by control and evaluation electronics 62.

The method is started in a step 100. In a step 102, it is checked if the detector registers a first radiant energy pulse, that is, a peak. If that is not the case, then the inquiry made by step 102 is repeated until a first peak 82 is registered. A first peak is detected, for example, by the fact that a signal height of the detector signal is above a predetermined threshold value.

A registration of a first peak 82 taking place in step 102 results in a timer's being started in a step 104 following step 102.

An inquiry step 106 follows step 104. In this inquiry step 106, it is decided, in each instance, which of the two inquiry steps 108, 110 will be carried out as a next step. To that end, in step 106, it is checked if a second peak 84 has been registered since the starting of the timer occurring in step 104. A second peak 84 is detected, for example, by the fact that a signal height of the detector signal is above a predetermined threshold value. The threshold values for detecting a first peak 82 and a second peak 84 may be equal, or they may differ from each other.

If no second peak 84 is registered in step 106, which corresponds to a negative answer to inquiry step 106, the method branches to step 108, in which it is checked if a first time span t1 has elapsed since the starting of the timer. First time span t1 corresponds to the maximum spacing of peaks 82, 84 of a double peak 80, which has been generated by a single particle. If time span t1 has not yet elapsed since the starting of the timer, the program branches back to step 106. Accordingly, steps 106 and 108 form a wait loop. If the time elapsed since the starting of the timer is greater than first time span t1, the wait loop is exited from step 108 into step 112, in which the first peak is evaluated.

This path leading to step 112 is characteristic of particles, which do not generate a double peak. Consequently, particles, which pass through hot spot 22 of particle sensor 16 and generate, in this instance, a single peak per particle, are detected and evaluated.

On the other hand, particles, which fly past hot spot 22 laterally, may produce double peaks 80. They are intended to be either counted as particles or not counted as particles as a function of how long the lateral distance is. They should then be counted, if the spacing of individual peaks 82, 84 of a double peak 80 is comparatively small, whereas in the case of comparatively large spacing, they should not be counted.

In these two cases, wait loop 106, 108, which includes the two inquiry steps 106 and 108, is exited from inquiry step 106 into inquiry step 110. In this manner, these two cases are distinguished from a single peak of a particle flying through spot 22: The inquiry made by inquiry step 106, as to whether a peak has been registered, is answered with yes before time span t1 elapses.

In subsequent inquiry step 110, it is checked if the time span elapsed since the starting of the timer in step 104 is greater than a predefined time span t2; the length of time span t2 being less than the length of time span t1. The length of predefined time span t2 is a function of the magnitude of the minimum lateral distance from spot 22 of the particles, which are flying past and are still intended to be counted. The greater this distance is, the greater the time span t2 to be specified must be.

If the time t elapsed since the starting of the timer is less than time span t2, then the method branches to step 112, in which an evaluation takes place. This permits the distinguishing of particles, which still fly close enough past spot 22, in order to be heated up to their saturation temperature, from such particles, which fly past spot 22 at such a far lateral distance, that they are no longer heated up to their saturation temperature.

In this context, the evaluation includes at least a rating of the peak as a particle, which may be accomplished, for example, by incrementing a particle count, as well as the evaluation of the height of the first peak 82 of a double peak 80. In this instance, the registered height is assigned to a particle size. The size of the particles is linked to the height of the peak in such a manner, that larger particles also generate higher peaks. During the evaluation, this interrelationship is taken into account, since higher peaks are assigned correspondingly greater values of the particle size.

Subsequently to step 112, in step 114, the timer is reset to its starting value, for example, zero. This is followed once more by step 102, in which the registration of a peak is awaited.

If the time t elapsed since the starting of the timer is not less than time span t2, then the method branches from step 110 directly to step 114, which means that the associated particle is not evaluated. In this manner, signals of particles, which fly past the spot laterally at a distance too large for an evaluation, are filtered out (not evaluated).

Time span t2 is specified, in particular, in such a manner, that particles, which generate such double peaks, are not evaluated. When time span t measured by the timer exceeds the duration of time span t2, step 110 allows the method not to branch to step 112 for the evaluation. Instead, in the exemplary embodiment represented, the method branches to step 114, in which the timer is reset to its starting value. In this case, as well, the program subsequently returns to step 102, so that further particles may be counted and evaluated.

1-14. (canceled)

15. A method for operating a particle sensor, the particle sensor including a laser module having a laser, a detector configured to detect thermal radiation, and an optical element positioned in the optical path of the laser of the laser module, the optical element being configured to focus laser light emanating from the laser module onto a spot, in order to induce a particle to emit light at a position of the spot, and the detector is positioned in the particle sensor in such a manner that it detects radiation emanating from the spot, the method comprising:
subjecting output signals of the detector to filtering, by which output signals generated by particles not sufficiently heated are excluded from further evaluation.

16. The method as recited in claim 15, wherein the filtering takes place in such a manner that peaks, which have a characteristic double-peak structure, are excluded from the further evaluation.

17. The method as recited in claim 16, wherein the characteristic double-peak structure is detected using a signal processing method.

18. The method as recited in claim 17, wherein the signal processing method is carried out using pattern recognition by artificial intelligence, or fitting of a curve of the double-peak structure to a sample curve shape, or by algorithms for finding high reference points of the double-peak structure and for evaluating an interval of the high reference points.

19. The method as recited in claim 16, wherein the filtering is based on an evaluation of the time interval of peaks in the output signal of the detector.

20. The method as recited in claim 19, wherein a first peak is detected in the output signal of the detector, and a decision as to whether the detected first peak is counted as an event indicating a particle is a function of whether a further peak is detected in the output signal of the detector within a specified first period of time, which begins with the detection of the first peak.

21. The method as recited in claim 20, wherein the first period of time is specified as a function of a speed of fluid or gas, which transports the particles.

22. The method as recited in claim 20, wherein a time span which has elapsed since the detection of the first peak is measured, and the first peak is counted as a particle if no further peak is detected in the output signal of the detector within the specified first period of time.

23. The method as recited in claim 22, wherein if a second peak is detected within the first period of time, it is checked whether the second peak has been detected within a second period of time, which is shorter than the first period of time, and if the second peak is detected within the second period of time, the first peak and the second peak of a double peak are counted together as a particle.

24. The method as recited in claim 20, wherein a height of a peak is evaluated as a measure of a size of the particle.

25. The method as recited in claim 24, wherein a height of the first peak of the double peak structure is evaluated as a measure of the size.

26. The method as recited in claim 15, wherein the radiation emanating from the spot is subjected to wavelength filtering, in which wavelengths in a wavelength range of the laser beam are excluded.

27. A control unit for operating a particle sensor, the particle sensor including a laser module having a laser, a detector configured to detect thermal radiation, and an optical element positioned in the optical path of the laser of the laser module, the optical element being configured to focus laser light emanating from the laser module onto a spot, and the detector is positioned in the particle sensor in such a manner that it detects radiation emanating from the spot, the control unit being configured to:
detect a first peak in the output signal of the detector; and
subject output signals of the detector to filtering, by which output signals generated by particles not sufficiently heated are excluded from further evaluation.

28. The control unit as recited in claim 27, wherein the control unit is further configured to:
filter the output signals of the detector in such a manner that peaks, which have a characteristic double-peak structure, are excluded from the further evaluation.
